(19) United States
(12) Patent Application Publication
(10) Pub. No.: US 2006/0262210 A1
(43) Pub. Date: Nov. 23, 2006

(54) Method and apparatus for column-wise suppression of noise in an imager

(75) Inventors: Scott Smith, Saratoga, CA (US); Michael Malone, San Jose, CA (US)

Correspondence Address: DICKSTEIN SHAPIRO LLP, 1825 EYE STREET NW, Washington, DC, 20006-5403, US

(73) Assignee: Micron Technology, Inc.

(21) Appl. No.: 11/132,181

(22) Filed: May 19, 2005

(51) Int. Cl. H04N 5/335

(52) U.S. Cl. 348/308

(57) ABSTRACT

A method, column circuit, imager and imaging system having noise-reducing and memory-saving capabilities. An offset value for each of a plurality of pixel columns in the imager is generated. A predetermined number of the plurality of pixel columns having corresponding offset values that are greater in value than all other generated offset values are selected. Noise is reduced in each of the selected pixel columns by applying the corresponding offset values to pixel outputs from each selected pixel column. The memory requirements of the imager are reduced by only storing offset values corresponding to the selected pixel columns. Memory is also conserved by reducing bit depth and only storing a single offset value for each of the plurality of pixel columns.

### FIELD OF THE INVENTION

The present invention relates generally to semiconductor imagers. More specifically, the present invention relates to a reduced-memory technique for fixed-pattern noise reduction in semiconductor imagers.

### BACKGROUND OF THE INVENTION

Various types of imagers or image sensors are currently used, including charge-coupled device (CCD) image sensors and complementary metal-oxide semiconductor (CMOS) image sensors. CMOS technology offers many benefits, such as lower cost, ease of manufacturing, and a higher degree of integration over the CCD image sensors. However, a drawback of the CMOS image sensor technology is the presence of fixed-pattern noise (FPN). Fixed pattern noise is generated from a mismatch of circuit structures due to variations in the manufacturing processes of integrated circuits. The effect of fixed pattern noise in a CMOS image sensor is that groups of pixels, typically each column in a sensor array, exhibit relatively different strengths in response to uniform input light. FIG. 1 demonstrates the effect of fixed pattern noise on an image. In FIG. 1, the actual image 110 is sensed by the CMOS image sensor 120 via a sensor array 130. The sensor array 130 includes a matrix of pixel cells 132. Because of noise in the sensor array 130, a noise-corrupted image 140 is generated by the CMOS image sensor 120. Fixed pattern noise is largely responsible for the column-wise distortion apparent in the noise-corrupted image 140.

Fixed pattern noise is not the only noise source existent in a CMOS image sensor. However, fixed pattern noise is largely independent of the other noise sources. Specifically, reducing the variance of column-wise fixed pattern noise with respect to the variance of other pixel-wise noise sources can reduce the appearance of the column-wise fixed pattern noise as an artifact in an image. In general, if the standard deviation, or square root of the variance, of the column-wise fixed pattern noise is 5 to 6 times smaller than other pixel-wise noise sources, then the human eye will not be able to detect the presence of the column-wise fixed pattern noise.

To remove the effect of fixed pattern noise, conventional calibration processes involve measuring an output based on a known optical input and comparing it against an expected value. In CMOS image sensors, a light of known intensity and frequency is typically shone onto the sensors and used as the input calibration signal. In some cases, output from inactive dark pixel sensors may also be used during calibration to compare the sensors' output to an expected dark output. In principle, if there is no mismatch in the sensor devices, the voltage signal output from every pixel cell should be identical. In reality, however, significant differences in signal output values are read out between the pixel columns of a sensor array, even when a uniform input light stimulus is applied to the array. The difference between the pixel signal output values and the expected pixel signal output values is typically referred to as a pixel offset. The pixel offsets are computed and then stored for use in calibrating the entire sensor array.

In a conventional sensor array calibration, or offset reduction procedure, the calculated offsets are applied to the output of each pixel during normal image sensor operation. A pixel whose un-calibrated output was higher than expected will have its signal output value reduced by the amount of its corresponding scaled offset value. Similarly, a pixel whose un-calibrated output was lower than expected will have its signal output value increased by the amount of its corresponding scaled offset value. Any change in operating mode that would affect the offset values will result in a necessary recalculation of offset values for each pixel.

Storing pixel offset values poses tremendous challenges. Conventional calibration techniques may require memory to store an offset value for each pixel, or, more commonly, an average offset value for each column of pixels in the sensor matrix. In the latter case, because each column may contain multiple channels (relating to multiple colors), multiple average offset values for each column may be required. CMOS image sensors that use a Bayer Color Filter Array (Bayer CFA) have two channels for each column. Pixels within a column are associated with and alternate between channels such that, for example, every pixel on an odd-numbered row outputs a signal corresponding to a first channel, and every pixel on an even-numbered row outputs a signal corresponding to a second channel. Columns stagger the channel outputs in a checkerboard pattern. The resulting number of offset values to be stored becomes 2N, where N is the number of columns in the sensor array. These potentially large storage requirements also translate into a similarly large memory footprint in or accompanying the CMOS imager device, which also means greater expense and longer calibration procedure times.

There is, therefore, a need or desire for a method and apparatus for both minimizing fixed pattern noise in a CMOS imager and reducing the memory used for such minimization.

### BRIEF SUMMARY OF THE INVENTION

The invention provides a method and apparatus that both minimizes fixed pattern noise in a CMOS imager and reduces the memory used for such minimization.

An offset value for each of a plurality of pixel columns in the imager is generated. A predetermined number of the plurality of pixel columns having corresponding offset values that are greater in value than all other generated offset values are selected. Noise is reduced in each of the selected pixel columns by applying the corresponding offset values to pixel outputs from each selected pixel column. The memory requirements of the imager are reduced by only storing offset values corresponding to the selected pixel columns. Memory is also conserved by reducing bit depth and only storing a single offset value for each of the plurality of pixel columns.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 is a block diagram of a prior art imaging system that shows the effects of fixed-pattern noise on an image processed by the system;

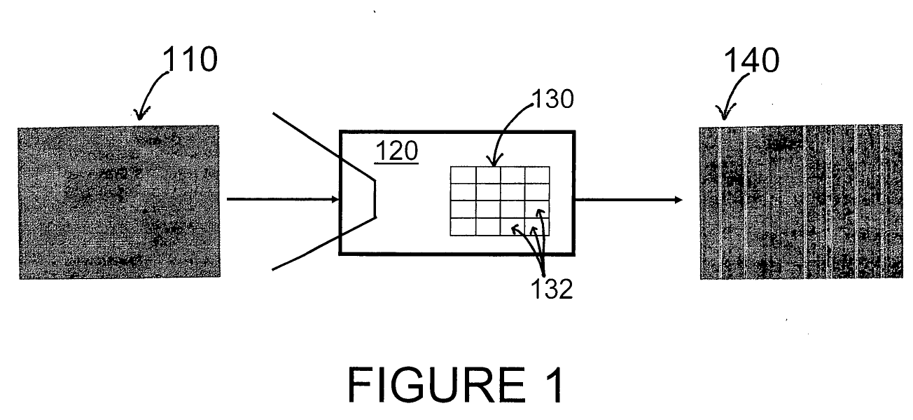

FIG. 2 is a block diagram of a CMOS sensor array, according to an exemplary embodiment of the present invention;

FIG. 3 is a flowchart of data collection steps, according to an exemplary embodiment of the present invention;

FIG. 4 is a flowchart of calibration steps, according to an exemplary embodiment of the present invention;

FIG. 5 is a flowchart of data collection steps, according to an exemplary embodiment of the present invention;

FIG. 6 is a block diagram of a CMOS sensor array, according to another exemplary embodiment of the present invention;

FIG. 7 is a flowchart of calibration steps, according to another exemplary embodiment of the present invention;

FIG. 8 is a block diagram of an imager, according to an exemplary embodiment of the present invention; and

FIG. 9 is a block diagram of an imaging system, according to an exemplary embodiment of the present invention.

### DETAILED DESCRIPTION OF THE INVENTION

The present invention is now described in more detail herein in terms of various exemplary embodiments. This is for convenience only and is not intended to limit the application of the present invention. In fact, after reading the following description, it will be apparent to one skilled in the relevant art(s) how to implement the following invention in alternative embodiments. Moreover, the present invention can be implemented using software, hardware or any combination thereof as is known to one of ordinary skill in the art.

In an embodiment of the present invention, column-wise fixed pattern noise is reduced such that its standard deviation is at least five times lower than that of other pixel-wise noise sources. This is achieved by only calibrating a predetermined number of pixel columns that have offset values that are greater than all other offset values. Because not all pixel-columns are corrected, the total amount of memory required in a silicon implementation is reduced.

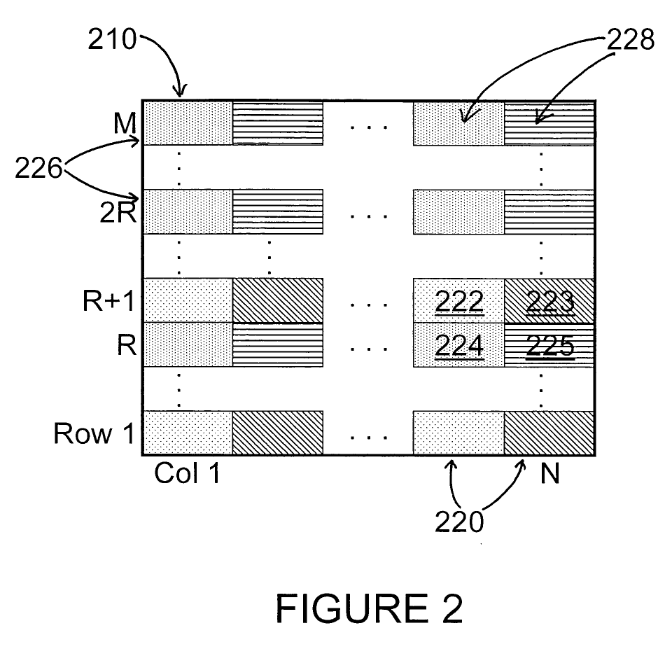

Referring now to FIG. 2, a CMOS sensor array 210 is shown containing N pixel columns 220 of pixels 228. Multiple channels may exist for each column, meaning that pixels in each column may be tuned to sense specific frequency ranges, and that identically tuned pixels will output signals along an output path specific for the represented frequency range. Here, for example, four channels 222, 223, 224, 225 exist, two channels 222, 224 for odd columns and two channels 223, 225 for even columns. Each pixel 228 only outputs on a single channel, either channel 222, 223, 224 or 225. Because of an alternating channel output pattern, any given pixel column 220 will only output to two of the four channels 222, 223, 224 and 225. The CMOS sensor array 210 is depicted with M rows 226. Hence, a given column 220 consists of M pixels 228, but a given channel within the column 220 is associated with only M/2 pixels 228.

When the CMOS sensor array 210 is calibrated, a reference or dummy signal is applied to the CMOS sensor array 210. The applied reference or dummy signal may be either a uniform incident light of known frequency or a signal reflecting the absence of any incident light. Reference signal outputs are then recorded from the pixels 228. In an effort to reduce time and memory requirements for calibration, in accordance with the invention, reference signal outputs need not be read out and stored from every pixel 228. Instead, only a sufficient number of reference signal outputs need be read out and stored from each column 220. If it is deemed that R reference signal outputs for each channel for each column would be sufficient, then, in the example of FIG. 2, only 2R pixels per column need be read out. In an embodiment of the present invention, R could equal 32, for example, meaning that 32 rows per color channel or 64 rows per column 220 need be read out in order to have sufficient data to properly calibrate the CMOS sensor array 210.

The process of applying, inputting and outputting reference or dummy signals may occur at chip startup, when the integration or exposure time may be set to a minimum to avoid measurement errors that result from pixel heating or dark current. The read out data may then be used to calibrate the CMOS sensor array 210 for any operation in the current operating mode of the imager. If the operating mode were to change, for example, to a binning mode, wherein the output from multiple adjacent pixels is combined to create a single output (in effect, creating a large pixel from several small pixels), the process of calculating and selecting average column offset values would need to be repeated to account for the effective change in offset values and number of columns. The signal measurements should be made at the highest analog gain setting to achieve the most accurate results possible. Future image acquisition procedures in the same operating mode, but at differing gain levels will utilize scaled-down results generated from the high gain settings. Generally, any scaling errors that may result during lower gain setting operation (e.g., 1× and 2× gains) will not be significant because the signal level is generally much higher than the noise at these gain levels.

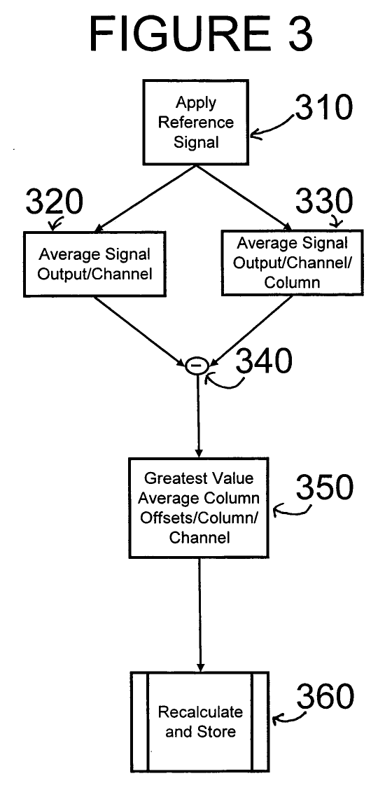

Referring now to FIG. 3, once the dummy or reference signal has been applied (block 310) to the CMOS sensor array 210 (see FIG. 2), the data collection and calibration steps may occur. In the data collection steps, an average value for each channel in the CMOS sensor array 210 (see FIG. 2) may be calculated (block 320). The average value for each channel is calculated by summing the reference signal outputs for each pixel related to the given channel within the 2×R×N region. Thus, the average reference signal output for each channel may be calculated according to Equations 1.1-1.4.

$$\begin{matrix}{μ}_{channel 1} = \frac{2}{R \cdot N} {\sum }_{row = 1 , 3 , 5 …}^{2 R} {\sum }_{col = 1 , 3 , 5 …}^{N} {P}_{col , row} . & Eq . 1.1 \\ {μ}_{channel 2} = \frac{2}{R \cdot N} {\sum }_{row = 1 , 3 , 5 …}^{2} {\sum }_{col = 2 , 4 , 6 …}^{N} {P}_{col , row} . & Eq . 1.2 \\ {μ}_{channel 3} = \frac{2}{R \cdot N} {\sum }_{row = 2 , 4 , 6 …}^{2 R} {\sum }_{col = 1 , 3 , 5 …}^{N} {P}_{col , row} . & Eq . 1.3 \\ {μ}_{channel 4} = \frac{2}{R \cdot N} {\sum }_{row = 2 , 4 , 6 …}^{2 R} {\sum }_{col = 2 , 4 , 6 …}^{N} {P}_{col , row} . & Eq . 1.4\end{matrix}$$

In addition to calculating the average reference output signals for each channel, the average reference output signals for each channel per column need also be calculated (block 330). This may be achieved by summing a given channel output for a given column, and then dividing this sum by the number of occurrences of the given channel within the given column. Processing block 330 may be summarized by Equations 2.1 and 2.2.

$$\begin{matrix}{μ}_{col , channels 1 or 2} = \frac{1}{R} {\sum }_{row = 1 , 3 , 5 …}^{2 R} {P}_{col , row} . & Eq . 2.1 \\ {μ}_{col , channels 3 or 4} = \frac{1}{R} {\sum }_{row = 2 , 4 , 6 …}^{2 R} {P}_{col , row} . & Eq . 2.2\end{matrix}$$

where col=1,2,3, . . . n.

Afterwards, an average column offset for each column and channel may be calculated by determining the difference between μ_{channel} and μ_{col, channel} (block 340). Note that in Equations 2.1 and 2.2, only n average column offsets are determined at a time, where n represents the number of average column offsets that may be stored in a memory block at one time.

For every n average column offsets computed and stored, the locations of a predetermined number of the average column offsets that are greater in value than all other average column offsets are identified and stored (block 350). In an exemplary embodiment, the n²/N greatest value average column offsets are determined for every n columns. Once determined, the locations of the columns associated with the greatest value average column offsets are stored.

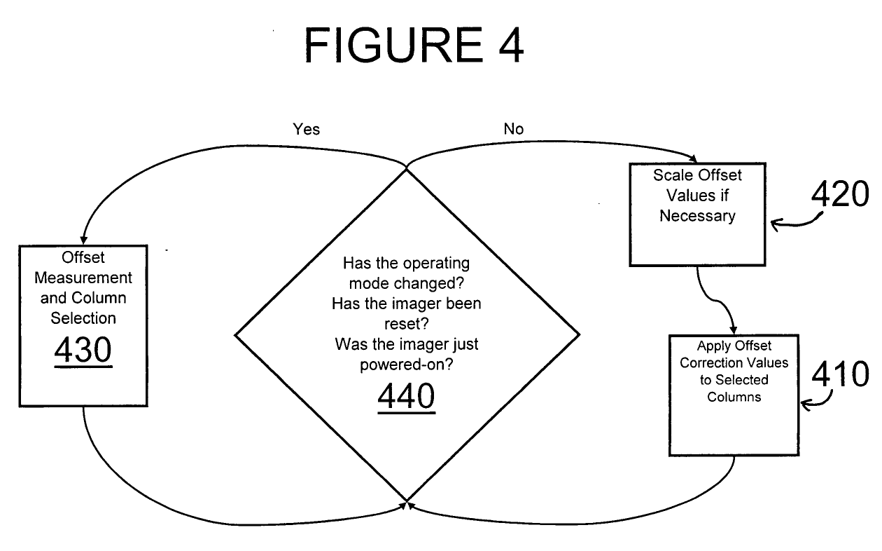

Once the columns with the greatest value average column offsets have been located for all N columns, the average column offsets for the specified columns may be re-measured and re-calculated (block 360). These re-measured average column offsets for the selected columns become the offset correction values that will be applied to calibrate any image acquired by the CMOS image array in the current operating mode, as demonstrated in FIG. 4.

Referring now to FIG. 4, offset correction values for selected pixel columns are summed with the signal outputs arising from the respective pixel columns (block 410). As mentioned previously, if a different gain level is being used, the column offset correction values will need to be appropriately scaled prior to being summed with the signal outputs from the respective columns (block 420). If the operating mode were to change, or if the CMOS image sensor is reset, as indicated in block 440, the offset measurement and calibration process of FIG. 3 would need to be repeated (block 430).

A significant advantage of this fixed pattern noise-reducing technique, besides the reduction of noise, is the overall reduction in memory used during the process. In the traditional method of correcting all columns with the same precision, assuming a four-channel sensor array, the memory requirement is shown below in Equation 3, where N represents the total number of columns, R is the necessary number of sampled pixels for a given channel in a given column, and B is the bit depth, or the number of bits used to store the average column offset values.
totalmemory_{traditional}=2N·(log₂(R)+B) Eq. 3.

However, using this exemplary embodiment, the memory requirement reduces to:
totalmemory_{reduced}=2 n·(log₂(R)+B)+N Eq. 4.

The reduced memory results from the fact that only n average column offset values of bit depth B need be stored, instead of N columns (which is all the columns in the array). The additional N bits shown in Equation 4 relate to a 1×N array necessary to store the location information of the columns selected for calibration.

In another exemplary embodiment, memory requirements may be further reduced by (1) changing the number of rows sampled to obtain average column offset values and (2) changing the bit depth of stored average column offset values. As such, the memory requirement of the additional embodiment becomes:
totalmemory_{reduced}=n·(log₂(R)+b)+N·b Eq. 5.

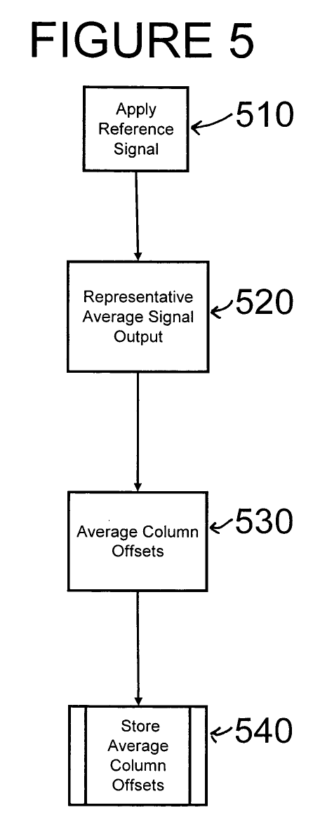

The exemplary embodiment described by Equation 5 is used in the method illustrated in FIG. 5. In this embodiment, a reference or dummy signal is applied to the CMOS sensor array, and the reference signal output is recorded from the pixels (block 510). A representative average reference signal output may be calculated for the entire CMOS sensor array by averaging the reference signal output from each pixel over all N columns and over a sufficient number of rows AR (block 520). In measuring the reference signal output, gain levels for each channel should be set to a maximum value. The calculations are performed according to Equation 6 below.

$$μ = \frac{1}{AR \cdot N} {\sum }_{row = 1 , 2 , 3 …}^{A} {\sum }_{col = 1 , 2 , 3 …}^{N} {P}_{col , row} . \qquad Eq . 6$$

Next, average column offset values may be calculated (block 530). This may be done in increments of n columns, where n is a subset of the total N columns, and where n represents the number of average column offset values that may be stored in a given memory block at one time. To determine the n average column offset values, only a sufficient number, R, of reference signal outputs need be read from each column. In this embodiment, no differentiation is made between the various channel outputs within a column at this stage of the process. Hence, only R reference signal outputs are read for each column (as opposed to 2 R in the previous embodiment). For each n columns, the average column offset value may be calculated according to equation 7.

$${P}_{col}^{′} = \frac{1}{R} {\sum }_{row = 1 , 2 , 3 …}^{R} ( {P}_{col , row} - μ ) . \qquad Eq . 7$$

For each of the n average column offset values, only the upper b bits of the value need be stored (block 540). In effect, this reduces the bit depth of the average column offset values from B to b. Although this results in less precision of the average column offset values, experiments have shown that full precision is not required to adequately remove the visual effects of fixed pattern noise in the image.

In this manner, the average column offset values may be determined and stored for each of the N/n subsets of columns, resulting in a total of N average column offset values, each with a bit depth of b bits. These N average column offset values remains constant until the imager is either reset or a mode change occurs.

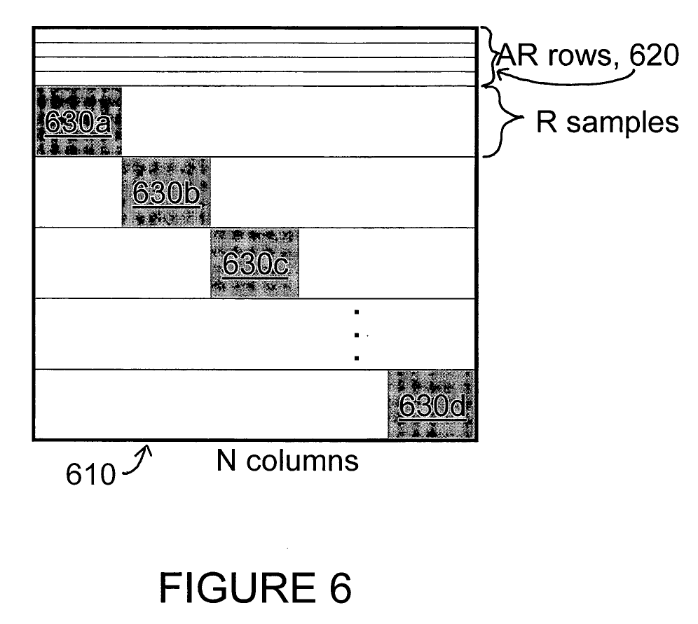

This method of determining average column offset values also effectively reduces the time required to measure and determine the offset values, which both reduces memory requirements and improves performance. Referring now to FIG. 6, a simplified CMOS sensor array 610 is depicted with N columns and a large number of rows. In the CMOS sensor array 610, a given row is read in its entirety at a given moment in time. At a next moment in time, the next row is read in its entirety. Hence, in the CMOS sensor array 610, if rows are read from the top down, the top rows will be read before the bottom rows. In an embodiment of the present invention, all N columns of the top AR rows 620 will be read first in order to determine a representative average offset value. Then, a block 630 of R rows by n columns, column-wise shifted, will be read-out to determine the average column offset values for those n columns. For each R by n block 630a, 630b, 630c, 630d, the average column offset values are determined. Thus, all of the average column offset values may be determined during the duration of a single read out of the CMOS sensor array 610.

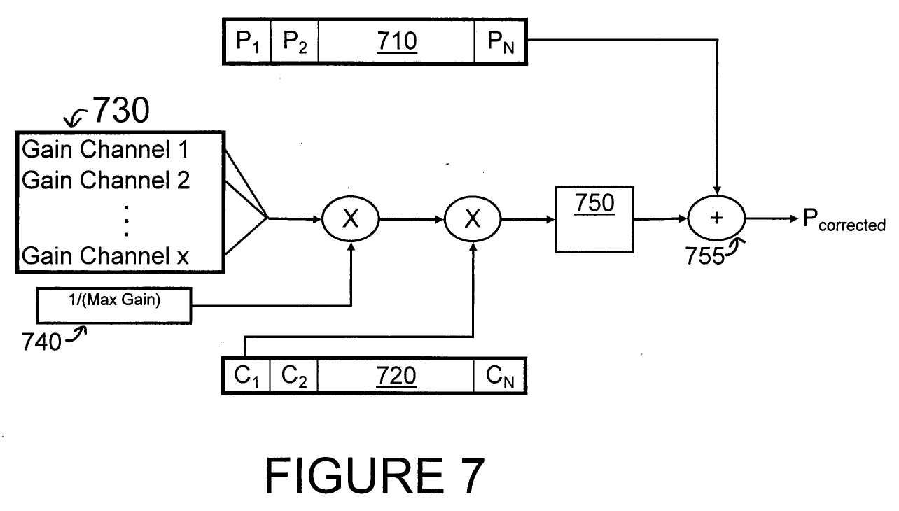

FIG. 7 depicts the process which occurs when an acquired image is to be corrected for fixed pattern noise using the generated average column offset values described in FIGS. 5 and 6. During fixed pattern noise correction, each pixel signal output 710 is corrected by summing the output 710 with a corresponding appropriately scaled average column offset value at block 755. Because the average column offset values 720 were measured at the highest gain setting and represent an average offset value across all channels, the applied average column offset value (applied to block 755) must first be appropriately scaled to account for both the gain settings of the entire acquired image and also channel variations (since differences in channel output were ignored in the calibration stage). The required scaling factors may be generated by determining a ratio of current gain setting for each channel 730 to a maximum gain setting 740. The resulting scaling factors are then used to scale the corresponding average column offset values 720, which are then summed with the appropriate pixel signal outputs 710.

Additionally, although the bit depth of the average column offset values 720 has been reduced, a bit shifter 750 may be provided in order to achieve the desired correction range, thus accounting for either very large or very small average column offset values 720.

In an additional embodiment of the invention, a threshold offset value is utilized to add greater flexibility to the noise-reduction process. Instead of applying the calculated average column offset values to a predetermined number of pixel columns, a maximum offset value could be determined and then used as a threshold level; any pixel columns with average column offset values exceeding the threshold offset value will be modified in a noise-reducing process according to the process already described.

Similarly, a minimum offset value could be determined and used as a minimum threshold offset value. In an embodiment wherein a minimum threshold offset value is determined, pixel columns with average column offset values below the minimum threshold offset value are modified so as to increase the overall offset values of the selected pixel columns. This method, though less preferred, would still result in significant smoothing of the output image.

In a further embodiment, the applied average column offset values need not be precise. In other words, by applying a noise-reducing factor that is only similar in value to the calculated average column offset value, a noise-reducing effect will still be evident. Exact precision is not necessary.

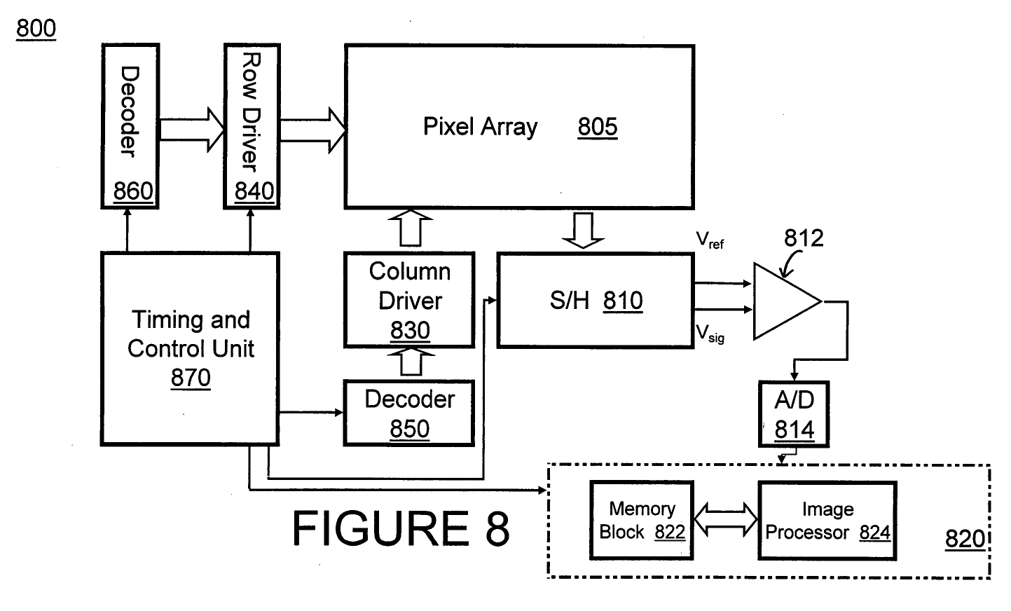

Combined fixed pattern noise and memory reduction may be achieved in a CMOS imager through an appropriate implementation of the methods described above. As shown in FIG. 8, the CMOS imager 800 of the invention includes a pixel array 805, column drivers 830, row drivers 840, column decoders 850, row decoders 860 and a timing and control unit 870. Pixel signals from the pixel array 805 are read column-wise and temporarily stored in the sample and hold circuit 810. Representative pixel outputs are determined by calculating the difference between a background or reference signal, V_{ref}, and the stored pixel signal, V_{sig}, as indicated in block 812. The resulting representative pixel outputs are converted by an analog to digital converter 814. The digital pixel outputs are then transferred to the noise reducing circuit 820, which includes an image processor 824 and a memory block 822. The memory block 822 has sufficient capacity to store the average column offset values at the required bit depth (as required by the embodiment of the invention chosen). The image processor 824 applies calculated average column offset values to the digitized pixel output signals. The timing and control unit 870 acts as a controller for the column decoder 860, the row driver 840, the row decoder 850, and the sample and hold circuit 810. The timing and control unit 870 also transmits information pertaining to the analog gain settings of the imager 800. The analog gain setting information is digitized by the analog to digital converter 814 and is then used by the image processor 824 to appropriately scale the calculated average column offset values.

An imager as depicted in FIG. 8 may be manufactured using processes known to those skilled in the relevant art(s). In short, an imager may be fabricated by fabricating a pixel array, said pixel array being organized into a plurality of rows and columns. In imagers where a dummy or reference signal is generated, a plurality of reference pixels must also be fabricated, with at least one reference pixel for each column of the pixel array. Electrical connections to allow pixel output and control must also be fabricated. The control and processing structures depicted in FIG. 8 could also be fabricated, or could be implemented via programmable logic structures.

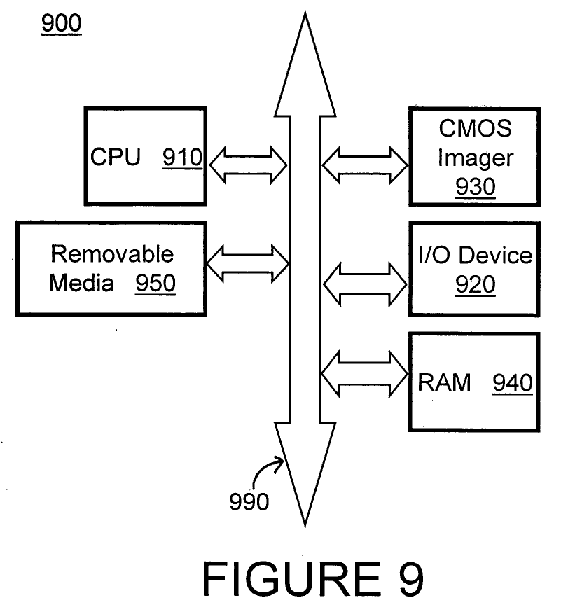

A typical processor based system 900, which includes a CMOS imager device 930 according to the present invention is illustrated in FIG. 9. A processor based system is exemplary of a system having digital circuits which could include CMOS imager devices. Without being limiting, such a system could include a computer system, camera system, scanner, machine vision system, vehicle navigation system, video telephone, surveillance system, auto focus system, star tracker system, motion detection system, or other image acquisition system.

A processor system, such as a camera system, for example, generally comprises a central processing unit (CPU) 910, for example, a microprocessor, that communicates with an input/output (I/O) device 920 over a bus 990. The CMOS imager 930 also communicates with the system components over bus 990. The computer system 900 also includes random access memory (RAM) 940, and, in the case of a computer system may include peripheral devices such as a removable memory 950 which also communicates with CPU 910 over the bus 990. CMOS imager 930 is preferably constructed as an integrated circuit which includes pixels containing a photosensor, such as a photogate or photodiode. The CMOS imager 930 may be combined with a processor, such as a CPU, digital signal processor or microprocessor, with or without memory storage in a single integrated circuit, or may be on a different chip than the processor.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments.

What is claimed as new and desired to be protected by Letters Patent of the United States is:

1. A method of reducing column noise in an imager, said method comprising the steps of:
generating an offset value for each of a plurality of pixel columns in the imager, said offset value derived from a plurality of pixel output values;
selecting a number of the plurality of pixel columns which have offsets which exceed a set criteria; and
applying a noise-reducing factor to pixels in said selected pixel columns.

2. The method of claim 1, wherein said noise-reducing factor corresponds to said offset values of said pixel columns.

3. The method of claim 1, wherein said generating step comprises:
calculating an average column output value for each of the plurality of pixel columns, said average column output value calculated from the plurality of pixel output values in each corresponding pixel column;
determining an average pixel output value for all of the plurality of pixel output values; and
finding the difference between the average column output value and the average pixel output value.

4. The method of claim 1, wherein the selected number of the plurality of pixel columns is a predetermined number.

5. The method of claim 1, wherein the selected number of the plurality of pixel columns is equal to a number of generated offset values that exceed a predetermined threshold offset value.

6. The method of claim 5, wherein the selected number of the plurality of pixel columns is equal to a number of generated offset values that are greater than a predetermined threshold offset value.

7. The method of claim 5, wherein the selected number of the plurality of pixel columns is equal to a number of generated offset values that are less than a predetermined threshold offset value.

8. The method of claim 1, wherein the noise-reducing factor is applied by either adding to or subtracting from the plurality of pixel outputs from the corresponding selected pixel column so as to shift the plurality of pixel outputs in the direction of a predetermined threshold offset value.

9. The method of claim 1, wherein the noise-reducing factor is applied by either adding to or subtracting from the plurality of pixel outputs from the corresponding selected pixel column so as to shift the plurality of pixel outputs in the direction of an average pixel output value for all of the plurality of pixel output values.

10. The method of claim 1, wherein the noise-reducing factor is modified by a gain factor.

11. The method of claim 1, wherein said generating step occurs when the imager is first powered on.

12. The method of claim 1, wherein said generating step occurs when the imager is reset.

13. The method of claim 1, wherein said generating step occurs when the imager is at a highest gain setting.

14. The method of claim 1, wherein said generating step comprises generating multiple offset values for each of the plurality of pixel columns, the multiple offset values corresponding to multiple sets of color data in each of the plurality of pixel columns.

15. A method of reducing column noise in an imager, said method comprising the steps of:
generating an offset value for each of a plurality of pixel columns in the imager, said offset value derived from a plurality of pixel output values;
selecting a predetermined number of the plurality of pixel columns having corresponding offset values that are greater in value than the unselected generated offset values; and
reducing noise in each of the selected pixel columns by applying the corresponding offset values to pixel outputs from the selected pixel columns.

16. The method of claim 15, wherein said generating step comprises:
calculating an average column output value for each of the plurality of pixel columns, said average column output value calculated from the plurality of pixel output values in each corresponding pixel column;
determining an average pixel output value for all of the plurality of pixel output values; and
finding the difference between the average column output value and the average pixel output value.

17. The method of claim 15, wherein said predetermined number relates to a ratio between a total number of the plurality of pixel columns and a number of sampled subsets of the plurality of pixel columns.

18. The method of claim 15, wherein said reducing act comprises:
applying a gain factor to the corresponding offset values to obtain a plurality of gain modified corresponding offset values; and
summing each of the plurality of the gain modified corresponding offset values with each of the plurality of pixel outputs from the corresponding selected pixel columns.

19. The method of claim 15, wherein said generating step comprises generating multiple offset values for each of the plurality of pixel columns, the multiple offset values corresponding to multiple sets of color data in each of the plurality of pixel columns.

20. A method of reducing column noise in an imager, said method comprising the steps of:
generating a column offset value for each of the plurality of pixel columns in the imager, said column offset value derived from a plurality of pixel output values; and
reducing pixel output noise by applying a channel gain factor to said column offset values to obtain a plurality of channel modified column offset values, each of the plurality of channel modified column offset values pertaining to a set of channel-specific pixels in each of the plurality of pixel columns, and summing each of the plurality of channel modified column offset values with the corresponding pixel outputs.

21. The method of claim 20, wherein said generating step comprises:
calculating a representative average pixel output for all pixels in the plurality of pixel columns;
determining a pixel offset for each pixel in the plurality of pixel columns by finding the difference between the pixel output of each pixel in the plurality of pixel columns and the representative average pixel output for all pixels in the plurality of pixel columns; and
averaging the pixel offsets for each of the plurality of pixel columns to find an average column pixel offset for each of the plurality of pixel columns.

22. The method of claim 21, wherein said calculating step comprises using only a subset of pixel outputs from all of the plurality of pixel columns to find the representative average pixel output.

23. The method of claim 21, wherein said determining and averaging steps are applied sequentially to each of a plurality of subsets of the plurality of pixel columns.

24. The method of claim 20, further comprising the step of storing the plurality of column offset values using a reduced bit depth.

25. The method of claim 24, wherein the stored column offset values are bit-shifted according to a precision requirement of the imager.

26. An imager, comprising:
a pixel array having a plurality of column lines; and
a circuit coupled to said column lines and configured to generate an offset value for each of said plurality of column lines, select a predetermined number of the plurality of said column lines having corresponding offset values that are greater in value than the unselected generated offset values, and reduce noise in each of the selected pixel columns by applying a noise reducing factor approximately equal to the corresponding offset value to pixel outputs from the selected pixel columns.

27. The imager of claim 26, wherein said circuit generates an offset value by calculating an average column output value for each of said plurality of column lines, said average column output value calculated from the plurality of pixel output values in each corresponding column line, determining an average pixel output value for all of the plurality of pixel output values, and finding the difference between the average column output value and the average pixel output value.

28. The imager of claim 26, wherein said predetermined number relates to a ratio between a total number of said plurality of column lines and a number of sampled subsets of said plurality of column lines.

29. The imager of claim 26, wherein said circuit is further configured to apply a gain factor to the noise-reducing factor to obtain a plurality of gain modified noise-reducing factors, and to sum each of the plurality of the gain modified noise-reducing factors with each of the plurality of pixel outputs from the corresponding selected column lines.

30. The imager of claim 26, wherein said circuit is configured to generate multiple offset values for each of said plurality of column lines, the multiple offset values corresponding to multiple sets of color data in each of said plurality of column lines.

31. An imager, comprising:
a pixel array having a plurality of column lines; and
a circuit coupled to said column lines and configured to generate an offset value for each of said plurality of column lines in the imager, and reduce noise in each of said plurality of column lines by applying a channel gain factor to the corresponding offset values to obtain a plurality of channel modified offset values, each of the plurality of channel modified offset values pertaining to a set of channel data in each of said plurality of column lines, and to sum each of the plurality of channel modified offset values with a noise reducing factor approximately equal to the corresponding offset value to pixel outputs from the selected column lines.

32. The imager of claim 31, further comprising a memory configured to store a single offset value for each of said plurality of column lines, the offset values being stored with a reduced bit depth.

33. The imager of claim 31, wherein said circuit is further configured to calculate a representative average pixel output for all pixels in said plurality of column lines, to determine a pixel offset for each pixel in said plurality of column lines by finding the difference between the pixel output of each pixel in said plurality of column lines and the representative average pixel output for all pixels in said plurality of column lines, and to average the pixel offsets for each of said plurality of column lines to find an average pixel offset for each of said plurality of column lines.

34. The imager of claim 33, wherein said circuit is configured to use a subset of pixel outputs from all of said plurality of column lines to find the representative average pixel output.

35. The imager of claim 33, wherein said circuit is configured to determine pixel offsets by sequentially considering each of a plurality of subsets of the plurality of pixel columns.

36. The imager of claim 31, wherein the stored offset values are bit-shifted according to a precision requirement of the imager.

37. An imaging system, comprising:
an imager, said imager comprising:
a pixel array having a plurality of column lines; and
a circuit coupled to said column lines and configured to generate an offset value for each of said plurality of column lines, select a predetermined number of the plurality of said column lines having corresponding offset values that are greater in value than the unselected generated offset values, and reduce noise in each of the selected pixel columns by applying a noise reducing factor approximately equal to the corresponding offset value to pixel outputs from the selected pixel columns.

38. The imaging system of claim 37, wherein said circuit generates an offset value by calculating an average column output value for each of said plurality of column lines, said average column output value calculated from the plurality of pixel output values in each corresponding column line, determining an average pixel output value for all of the plurality of pixel output values, and finding the difference between the average column output value and the average pixel output value.

39. The imaging system of claim 37, wherein said predetermined number relates to a ratio between a total number of said plurality of column lines and a number of sampled subsets of said plurality of column lines.

40. The imaging system of claim 37, wherein said circuit is further configured to apply a gain factor to the noise-reducing factor to obtain a plurality of gain modified noise-reducing factors, and to sum each of the plurality of the gain modified noise-reducing factors with each of the plurality of pixel outputs from the corresponding selected column lines.

41. The imaging system of claim 37, wherein said circuit is configured to generate multiple offset values for each of said plurality of column lines, the multiple offset values corresponding to multiple sets of color data in each of said plurality of column lines.

42. A method of manufacturing an imaging device, said method comprising the acts of:
fabricating a pixel array, said pixel array being organized into a plurality of rows and columns;
fabricating a plurality of reference pixels, each reference pixel configured to output a reference signal to a corresponding column; and
fabricating a noise reducing circuit configured to generate average column offset values for each column by using a plurality of pixel output signals generated in response to the reference signals, and to apply said average column offset values to a selected number of the corresponding columns.
